(19) United States
(12) Patent Application Publication
(10) Pub. No.: US 2010/0106700 A1
(43) Pub. Date: Apr. 29, 2010

(54) Software system for entering food into a diet log where the dieter submits a photo of the food and another person records the food log data

(76) Inventor: Kevin Patrick Galligan, New York, NY (US)

Correspondence Address: Kevin Galligan, 235 E 95th St., Apt 8L, New York, NY, 10128, US

(21) Appl. No.: 12/604,648

(22) Filed: Oct. 23, 2009

Related U.S. Application Data
(60) Provisional application No. 61/108,356, filed on Oct. 24, 2008.

(51) Int. Cl. G06F 17/30; G06F 3/048

(52) U.S. Cl. 707/705; 715/764; 707/E17.005

(57) ABSTRACT

Keeping a food diet log has been shown to significantly improve diet quality and weight loss efforts. Keeping a diet log is generally tedious. To facilitate that, an image can be recorded of what the dieter is going to eat. This image is then sent to another person for diet log entry. The person entering the diet log may be someone known to the dieter, or a third party. The likely implementation would be the dieter takes a photo with a cell phone, which is submitted to a web application. Dieter pays for a person at the web company to enter the food info from the photo. Dieter may include supplemental information to help identify the food. Existing diet logs require tedious manual entry, and are difficult to use from a mobile device. Tedium and access are major impediments to continuing a diet log.

This non-provisional utility patent application relates to the provisional patent application for the same product, Application No. 61/108,356, with the same title “Software system for entering food into a diet log where the dieter submits a photo of the food and another person records the food log data”, filing date Oct. 24, 2008.

The present invention relates to a software system for entering food into a diet log where the dieter submits a photo of the food and another person records the food log data.

The product is comprised of the following components:

Part 1 is the digital photo device. This could be any device capable of taking and recording a digital photo. This would most likely be a cell phone.

Part 2 is the client photo management software, or PMS. This is not required in all scenarios. The PMS would likely be installed on a mobile phone, but could be configured for most digital devices. The PMS would use the digital device's camera to record a photo, and either send that photo to a central web service over the network, store the photo for later viewing or delivery, or send the photo with an alternate method such as email or MMS.

Part 3 is the central web service. This service would accept photos from registered client devices, likely sent from Part 2 (PMS). Once received, the photos would be routed based on client preferences. This would include, but not be limited to:
1. Saving for later. The person taking the photo would later view the photo themselves.
2. Send to personal third party. The photo would be viewable by a third party designated by the dieter user. This could be a parent, friend, or co-worker, but could also be anybody else they designate.
3. Send to other third party. This may be a paid or unpaid person, known to the dieter or unknown. If paid, likely scenarios would be they be employed by a web service company, a personal trainer, the dieter them self, a medical establishment, charitable organization, educational establishment, the dieter's employer or employer's health service provider, etc.

The central web service might include the diet log functionality, but also may just forward the entered food data to another entity. This might be the dieter themselves, a diet log website, place to gather info for the person's doctor or a medical study, or any other third party interested in the food data.

The product functions in the following manner.

Step 1 is recording the image. The digital device would require a camera. Either the device's software would be used to record the image, or Part 2 (PMS) would be installed on the device and used to record the image. If the device's software is used, the image would be delivered by email, MMS, network web post, or any other networked delivery method. The image could also be transferred manually by wired connection or flash card. If Part 2 (PMS) is installed, PMS will use the device's camera to record the image, and either store it locally for later transmission, or send it over the network to the central web service.

Step 2. Transmitting the image. The central web service would allow for posting of images over a network. The image could be sent in several ways:
1.—An http POST request. This would come directly from the Part 2 (PMS) software.
2.—An email. The email would be received by the central web service, and based on the sender's email, associated with the correct server account.
3.—An MMS message. The message would be received by the server and, based on the identity of the sender, associated with the correct server account.
4.—Posted to a web form.

Any other reasonable method of networked delivery could also be used. These could include fax, email to fax, web form to fax, http POST to fax, MMS to fax, fax to email, fax to http POST, fax to MMS. There are many combinations of transmission methods, which could expand into 3 or more combinations. Using a combination of transmission methods should not constitute a unique usage of the system and get around the patent claims. The spirit of the concept is using a method of transmission to send the image to the central web service.

Step 3. Routing the image and entering the food data. Once received, the web service will record the image and associated data into a database. Then, based on preferences, the image would “routed” to a user for food entry. “Routing” means adding to a user's or the likely implementation would involve taking a picture with a custom cell phone application, and transmitting that photo over the network to a web application. However, more generally, any method of taking a photo and any method of delivery should be sufficient. In this context, “digital device” is anything capable of recording a digital image, which would include a camera, phone, computer with a camera install, or a specialized device. Methods would include, but not be limited to,
1.—Taking a photo with a digital device, and sending it to an email address.
2.—Taking a photo with a digital device, and sending it in an MMS message.
3.—Taking a photo with a digital device and physically carrying that device or media to another digital device (another phone, camera, laptop or desktop computer, etc), and transmitting that photo to the other device. Transmission may be wireless, wired, or removing a flash card or other recording media (disk, cd/dvd) and connecting that to the other device.
4.—Taking photos with a digital device, and physically delivering that device to another person to use for entering data.
5.—Taking a photo with a digital device, and having that device “serve” the image over a network, similar to how a web server “serves” a file.

It would also be possible to take photos with an analog device, such as a traditional film camera. Although this would be fairly inefficient, it would still be possible to take these photos and deliver them in some manner for later data entry.

The context of use may be different than simply a dieter wanting to lose weight.

This could be used by people studying eating habits. The subjects of the study would take photos of what they eat to better track their food intake.

A similar system could be used to make sure people are taking their medications on a regular basis. Require the person to take photos of the pills they are taking with a specialized application.

Taking photos of food could help with cataloging food usage and better help with order management. This may or may not be a primary usage, but keeping track of consumption could help track how much food is being used and what likely needs to be purchased.

The data from the images could help direct advertising efforts to the dieter. In fact, money from advertisers might help offset the cost of paying for people to enter the food.

Statistics from the food entry could obviously be used to help advise diet patterns.

Location of the dieter when the photo is taken could help identify the food. For example, if the dieter is sitting in McDonalds, and if the phone has the ability to provide location data, the phone or central web service application would be able to provide that information to the person entering the food data. This would help pinpoint the actual food being eaten, portion size, and nutritional information.

Although not a pleasant thought, photos could be taken of feces and used in a medical or dietary context. Sort of the logical opposite of the main idea.

1. A software system including: a method to receive and store images of food and/or beverages, an interface to access these images, and a method to enter and associate with the image the details of the food and/or beverages in the images for the purpose of cataloging dietary information.

2. A software application consisting of: an image recording function to record images of food and/or beverages, and an image delivery function to deliver images to the software system in claim 1.

3. A software application for reviewing images and entering details which consists of: a method to access images of food and/or beverages from their storage location, a method to display those images to a human user, and a method to enter and store or transmit to an outside system information about the food and/or beverages in the image potentially including type of food, portion size, estimated portion size, brand, and dietary information such as calories, fats, protein, and carbohydrates.

4. A web-enabled server application including: an interface which accepts images of food and/or beverages and associates those images with a user entity on the system, a web interface to allow a web browser to display those images to a person for review, an input form to allow the person to enter information about the food and/or beverages in the image potentially including type of food, portion size, estimated portion size, brand, and dietary information, and a storage capability that will associate that entered food information with the user associated with the image.

5. A software transmission system consisting of: a networked interface that can forward the cataloged information gathered by the system in claim 1 to outside software systems.

6. A web-enabled server application including: a web interface to allow a web browser or networked device to display the dietary information collected by the system in claim 1, either in detail or in consolidated summary format.

7. A software application consisting of: an image recording function to record images of food and/or beverages, with associated time and/or location information, and an image delivery function to deliver images to the software system in claim 1.
